(19) United States
(12) Patent Application Publication
(10) Pub. No.: US 2006/0187348 A1
(43) Pub. Date: Aug. 24, 2006

(54) Synchronization signal generating apparatus and video signal processing apparatus

(75) Inventors: Tomoaki Daigi, Osaka (JP); Yoichiro Miki, Osaka (JP)

Correspondence Address: MCDERMOTT WILL & EMERY LLP, 600 13TH STREET, N.W., WASHINGTON, DC, 20005-3096, US

(73) Assignee: MATSUSHITA A ELECTRIC INDUSTRIAL CO., LTD.

(21) Appl. No.: 11/349,966

(22) Filed: Feb. 9, 2006

(30) Foreign Application Priority Data
Feb. 9, 2005 (JP) 2005-033585

(51) Int. Cl. H04N 5/04

(52) U.S. Cl. 348/500

(57) ABSTRACT

A synchronization signal generating apparatus comprises a cycle setting section, a pulse masking section, and a pulse generating section. The pulse masking section outputs a pulse train based on an input pulse train and cycle information. The pulse generating section outputs a pulse train based on the pulse train and cycle information output from the pulse masking section. When a synchronization signal is switched from the state of being in synchronization with the pulse train input from the pulse masking section to the independent state, the cycle setting section switches the cycle information upon receiving a pulse of the pulse train for the first time since a cycle selection signal was changed. On the other hand, when the synchronization signal is switched from the independent state to the state of being in synchronization with the pulse train input from the pulse masking section, the cycle setting section switches the cycle information after receiving a pulse of the pulse train since the cycle selection signal was changed.

### CROSS REFERENCE TO RELATED APPLICATIONS

This Non-provisional application claims priority under 35 U.S.C. §119(a) on Patent Application No. 2005-33585 filed in Japan on Feb. 9, 2005, the entire contents of which are hereby incorporated by reference.

### BACKGROUND OF THE INVENTION

1. Field of the Invention

The present invention relates to a synchronization signal generating apparatus, and more particularly, to a synchronization signal generating apparatus which can be preferably applied to various video signal processing systems.

2. Description of the Related Art

A synchronization signal is used as an operation reference signal for various video signal processing systems, and importantly, needs to be a stable and periodic signal. Therefore, conventionally, a synchronization signal generating apparatus comprising a plurality of synchronization signal generating sections has been disclosed. When an abnormality occurs in an operation of one synchronization signal generating section which is generating a current output synchronization signal, another synchronization signal generating section is switched into service to output a synchronization signal without interruption.

However, in this synchronization signal generating apparatus, when synchronization signals are switched, a discontinuity occurs in the synchronization signal. The discontinuity of synchronization disturbs processes of various video apparatuses. Particularly, a synchronization signal having a short synchronization period often causes a large disturbance, leading to significant noise in displayed video.

To avoid the discontinuity of a synchronization signal, conventionally, a synchronization signal generating apparatus illustrated in FIG. 12 has been proposed. This conventional synchronization signal generating apparatus comprises a currently-used synchronization signal generating section 21, a backup synchronization signal generating section 22, and a control section 23. A reference signal REF1 is transmitted from the currently-used synchronization signal generating section 21 to the backup synchronization signal generating section 22. By transmitting the reference signal REF1, which is in synchronization with an output synchronization signal SYNC1 of the currently-used synchronization signal generating section 21, to the backup synchronization signal generating section 22, an output synchronization signal SYNC2 of the backup synchronization signal generating section 22 is synchronized with the output synchronization signal SYNC1 of the currently-used synchronization signal generating section 21, thereby making it possible for the control section 23 to perform smooth switching of synchronization signals.

When a synchronization generating function possessed by a certain video signal processing system is achieved only by the above-described synchronization signal generating apparatus, one of the synchronization signal generating sections both generating a current output synchronization signal transmits a reference signal to the other synchronization signal generating section for the purpose of synchronization, thereby making it possible to output a stable synchronization signal without interruption unless both the synchronization signal generating sections fail to operate. However, assuming that the currently-used synchronization signal generating section transmits the reference signal to the backup synchronization signal generating section in only one way, i.e., that there is another video signal generating apparatus in the outside and a synchronization signal generating section therein is regarded as the currently-used synchronization signal generating section, a discontinuity occurs in a synchronization signal when a synchronization signal output from the backup synchronization signal generating section is switched to a synchronization signal output from the original currently-used synchronization signal generating section. In addition, it is likely that a synchronization signal having a short synchronization period, which is particularly problematic, occurs.

Specifically, a video signal processing apparatus illustrated in FIG. 13 will be described as an example. This video signal processing apparatus comprises an analog VTR 31 and a synchronization signal stabilizing section 32. The analog VTR 31 comprises a synchronization signal generating section 38. The synchronization signal stabilizing section 32 comprises a synchronization signal generating section 39, a video/synchronization signal synchronizing section (field memory) 41, and a control section 42. The analog VTR 31 outputs a video signal VIDEO1 and a synchronization signal SYNC1. The synchronization signal SYNC1 becomes unstable during special playback, such as fast forward, rewind, or the like, in the analog VTR 31. As a result, a malfunction occurs, depending on the degree of the unstable state and the video apparatus. To avoid such a malfunction, the video signal VIDEO1 and the synchronization signal SYNC1 are input to the synchronization signal stabilizing section 32, which tries to stabilize the synchronization signal, and after the stabilization process, the synchronization signal stabilizing section 32 outputs a video signal VIDEO and a synchronization signal SYNC.

In the video signal processing apparatus of FIG. 13, a synchronization signal generating section 33 corresponds to the synchronization signal generating apparatus of FIG. 12. When the analog VTR 31 performs a special playback and the synchronization signal SYNC1 output from the synchronization signal generating section 38 is disturbed, the synchronization signal SYNC output from the control section 42 is switched from the synchronization signal SYNC1 to a synchronization signal SYNC2 output from the synchronization signal generating section 39 in order to suppress a synchronization disturbance. FIG. 14 is a timing chart illustrating switching from the synchronization signal SYNC1 to the synchronization signal SYNC2. Because the synchronization signal SYNC2 is in synchronization with the synchronization signal SYNC1, a disturbance does not occur in the synchronization signal when switching.

On the other hand, after switching to the synchronization signal SYNC2, when an operation of the analog VTR 31 is changed from a special playback to a normal playback, the synchronization signal SYNC1 becomes stable, and therefore, it is desirable that the synchronization signal SYNC2, which operates independently of the analog VTR 31, be switched to the synchronization signal SYNC1. This is because, when the synchronization signal SYNC2, which is different from the original synchronization signal SYNC1, continues to be output, video becomes artificial in terms of continuity due to the synchronization switching process. It is preferable that the synchronization signal SYNC2 be synchronized with the synchronization signal SYNC1 before switching, also because a synchronization disturbance can be suppressed when switching. However, the synchronization signal SYNC1 is output from the analog VTR 31 which is independent of the synchronization signal stabilizing section 32, and therefore, it is not possible to synchronize the synchronization signal SYNC1 with the synchronization signal SYNC2 output from the synchronization signal stabilizing section 32. FIG. 15 is a timing chart indicating switching from the synchronization signal SYNC2 to the synchronization signal SYNC1. Because the synchronization signal SYNC1 cannot be synchronized with the synchronization signal SYNC2, the synchronization signal is disturbed when switching. For example, in this case, a synchronization signal having a short synchronization period may be generated as illustrated in FIG. 15.

### SUMMARY OF THE INVENTION

In view of the above-described problems, an object of the present invention is to provide a synchronization signal generating apparatus which suppresses a synchronization disturbance when an unstable synchronization signal is switched to an independent synchronization signal, and thereafter, the synchronization signal is switched to the original synchronization signal.

A synchronization signal generating apparatus according to the present invention comprises a cycle setting section of switching and outputting cycle information indicating a first cycle, corresponding to a given cycle selection signal, a pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state, and a pulse generating section of outputting a second pulse train, wherein when a pulse is input from the pulse masking section within the first cycle indicated by the cycle information after outputting a pulse, the pulse generating section outputs a next pulse, corresponding to the pulse input, and when the input is not present, the pulse generating section outputs a next pulse after the first cycle has elapsed. When the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information after receiving a pulse of the first pulse train for the first time since the cycle selection signal was changed.

In this invention, in the case where the cycle selection signal is changed when the second pulse train having a second cycle which is the same as that of the first pulse train is being output, the cycle information is switched when a pulse of any of the first and second pulse trains is received for the first time since then, and the cycle of the second pulse train is switched to the first cycle indicated by the cycle information. In the case where the cycle selection signal is changed when the second pulse train is output in the first cycle indicated by the cycle information, i.e., the cycle selection signal is changed in an independent synchronized state, the cycle information is switched after a pulse of the first pulse train is received, and the cycle of the second pulse train is returned to the second cycle which is the same as that of the first pulse train. This return occurs after the cycle selection signal is changed and after a pulse of the first pulse train is received. Therefore, a pulse of the second pulse train is not output, corresponding to the pulse output, so that a synchronization disturbance having a short period of time does not occur. Thus, a synchronization disturbance is suppressed when the independent synchronization signal is switched to the original synchronization signal.

Also, a synchronization signal generating apparatus according to the present invention comprises a cycle setting section of switching and outputting cycle information indicating a first cycle, corresponding to a given cycle selection signal, and outputting a mask signal, a first pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state, a pulse generating section of outputting a second pulse train, wherein when a pulse is input from the pulse masking section within the first cycle indicated by the cycle information after outputting a pulse, the pulse generating section outputs a next pulse, corresponding to the pulse input, and when the input is not present, the pulse generating section outputs a next pulse after the first cycle has elapsed, and a second pulse masking section of masking pulses of the second pulse train during a time when the mask signal is being output from the cycle setting section. When the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information after receiving a pulse of the second pulse train for the first time since the cycle selection signal was changed, and outputs the mask signal during a time from when the cycle selection signal was changed until when the cycle information is switched.

In this invention, in the case where the cycle selection signal is changed when the second pulse train having a second cycle which is the same as that of the first pulse train is being output, the cycle information is switched when a pulse of any of the first and second pulse trains is received for the first time since then, and the cycle of the second pulse train is switched to the first cycle indicated by the cycle information. In the case where the cycle selection signal is changed when the second pulse train is output in the first cycle indicated by the cycle information, i.e., the cycle selection signal is changed in an independent synchronized state, the cycle information is switched after a pulse of the second pulse train is received, and the cycle of the second pulse train is returned to the second cycle which is the same as that of the first pulse train. However, in this case, because the mask signal is output, the pulse of the second pulse train which is the basis of switching the cycle information is masked and does not appear in the output of the second pulse masking section. Thereafter, when a pulse of the first pulse train is output, the second pulse masking section outputs a pulse. Thus, by masking the pulse of the second pulse train which is the basis of switching the cycle information, a synchronization disturbance having a short period of time does not occur until a pulse of the first pulse train is subsequently output. Therefore, a synchronization disturbance is suppressed when the independent synchronization signal is switched to the original synchronization signal.

Also, a synchronization signal generating apparatus according to the present invention comprises a cycle setting section of switching and outputting cycle information indicating a first cycle, corresponding to a given cycle selection signal, a pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state, and a pulse generating section of outputting a second pulse train, wherein when a pulse is input from the pulse masking section within the first cycle indicated by the cycle information after outputting a pulse, the pulse generating section outputs a next pulse, corresponding to the pulse input, and when the input is not present, the pulse generating section outputs a next pulse after the first cycle has elapsed. When the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information after a phase difference between the first pulse train and the second pulse train becomes a predetermined value or less.

In this invention, in the case where the cycle selection signal is changed when the second pulse train having a second cycle which is the same as that of the first pulse train is being output, the cycle information is switched when a pulse of any of the first and second pulse trains is received for the first time since then, and the cycle of the second pulse train is switched to the first cycle indicated by the cycle information. In the case where the cycle selection signal is changed when the second pulse train is output in the first cycle indicated by the cycle information, i.e., the cycle selection signal is changed in an independent synchronized state, the cycle information is switched after a phase difference between the first pulse train and the second pulse train subsequently becomes a predetermined value or less, and the cycle of the second pulse train is returned to the second cycle which is the same as that of the first pulse train. This return occurs after the cycle selection signal is changed and after the phase difference between the first pulse train and the second pulse train becomes the predetermined value or less, i.e., after the phases of the first pulse train and the second pulse train become close to each other to some extent. Therefore, a synchronization disturbance is suppressed when the independent synchronization signal is switched to the original synchronization signal.

Preferably, when the cycle selection signal indicates selection of a change in the first cycle so that the size relationship is put into the first state, the cycle setting section gradually increases the first cycle.

In this invention, when the first cycle and the second cycle are equal to each other, and the phase difference between the first pulse train and the second pulse train does not change, the phase difference can be caused to be a predetermined value or less by gradually increasing the first cycle.

Also, a synchronization signal generating apparatus according to the present invention comprises a cycle setting section of switching and outputting cycle information indicating a first cycle, corresponding to a given cycle selection signal, a pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state, and a pulse generating section of outputting a second pulse train, wherein, when receiving a pulse from the pulse masking section, the pulse generating section sets a counter value to be an initial value corresponding to the first cycle indicated by the cycle information and starts to count down the counter value, and when receiving a next pulse from the pulse masking section or when the counter value becomes a first predetermined value, whichever comes first, the pulse generating section outputs a pulse. The counter value is reset to be the initial value after the counter value becomes the first predetermined value by counting down, and when the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information if the counter value is less than the second predetermined value upon receiving a pulse of the first pulse train for the first time since the cycle selection signal was changed.

In this invention, in the case where the cycle selection signal is changed when the second pulse train having a second cycle which is the same as that of the first pulse train is being output, the cycle information is switched when a pulse of any of the first and second pulse trains is received for the first time since then, and the cycle of the second pulse train is switched to the first cycle indicated by the cycle information. In the case where the cycle selection signal is changed when the second pulse train is output in the first cycle indicated by the cycle information, i.e., the cycle selection signal is changed in an independent synchronized state, the cycle information is switched after the count value counted by the pulse generating section reaches a predetermined value, and the cycle of the second pulse train is returned to the second cycle which is the same as that of the first pulse train. This return occurs after the cycle selection signal is changed and after the count value when the first pulse of the first pulse train is received becomes the predetermined value or less, i.e., after the phases of the first pulse train and the second pulse train become close to each other to some extent. Therefore, a synchronization disturbance is suppressed when the independent synchronization signal is switched to the original synchronization signal.

Specifically, the pulse generating section comprises an initial value determining circuit of determining the initial value from the cycle information, a down counter of reading the initial value from the initial value determining circuit and starting to count down the counter value either when receiving a pulse from the pulse masking section or when the counter value reaches the first predetermined value, a pulse generating circuit of outputting a pulse when the counter value reaches the first predetermined value, and a pulse synthesizing circuit of outputting a pulse received from any of the pulse masking section and the pulse generating circuit.

Also, specifically, in each of the above-described synchronization signal generating apparatuses, the first state is such that the first cycle is larger than the second cycle.

As described above, according to the present invention, when an independent synchronization signal during unstable synchronization and a synchronization signal during stable synchronization are switched, the occurrence of a synchronization signal having a short synchronization period, which is responsible for a malfunction of various video apparatuses, is suppressed, so that the synchronization signals can be smoothly switched.

### BRIEF DESCRIPTION OF THE DRAWINGS

FIG. 1 is a diagram illustrating a structure of a synchronization signal generating apparatus according to a first embodiment.

FIG. 2 is a timing chart of the synchronization signal generating apparatus of the first embodiment.

FIG. 3 is a diagram illustrating a structure of a synchronization signal generating apparatus according to a second embodiment.

FIG. 4 is a timing chart of the synchronization signal generating apparatus of the second embodiment.

FIG. 5 is a diagram illustrating a structure of a synchronization signal generating apparatus according to a third embodiment.

FIG. 6 is a timing chart of the synchronization signal generating apparatus of the third embodiment.

FIG. 7 is a timing chart of the synchronization signal generating apparatus of the third embodiment.

FIG. 8 is a diagram illustrating a structure of a synchronization signal generating apparatus according to a fourth embodiment.

FIG. 9 is a diagram illustrating an internal structure of a pulse generating section in the synchronization signal generating apparatus of the fourth embodiment.

FIG. 10 is a timing chart of the synchronization signal generating apparatus of the fourth embodiment.

FIG. 11 is a diagram illustrating a structure of a video signal processing apparatus according to the present invention.

FIG. 12 is a diagram illustrating a structure of a conventional synchronization signal generating apparatus.

FIG. 13 is a diagram illustrating a structure of a conventional video signal processing apparatus.

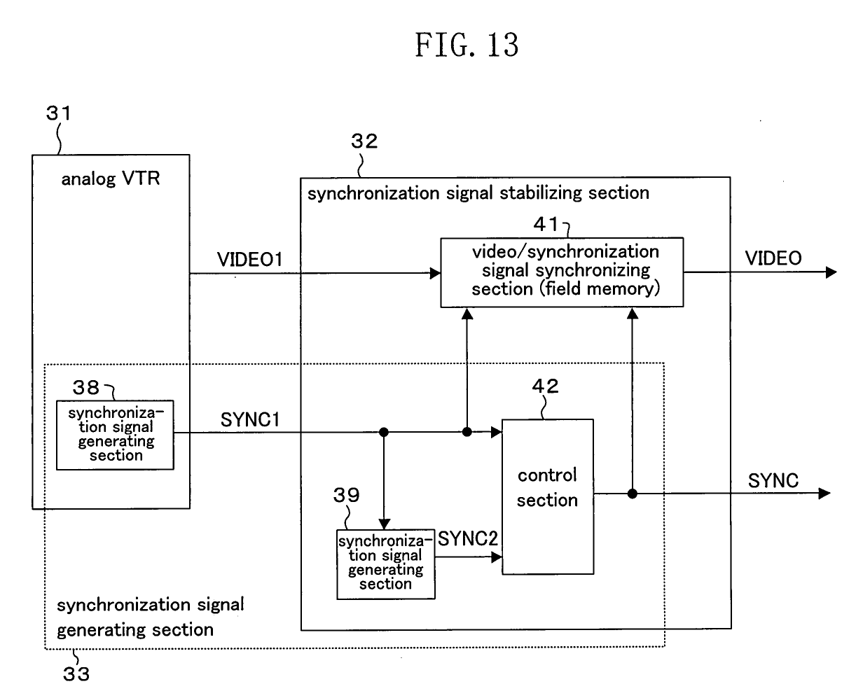

FIG. 14 is a timing chart illustrating conventional switching of synchronization signals.

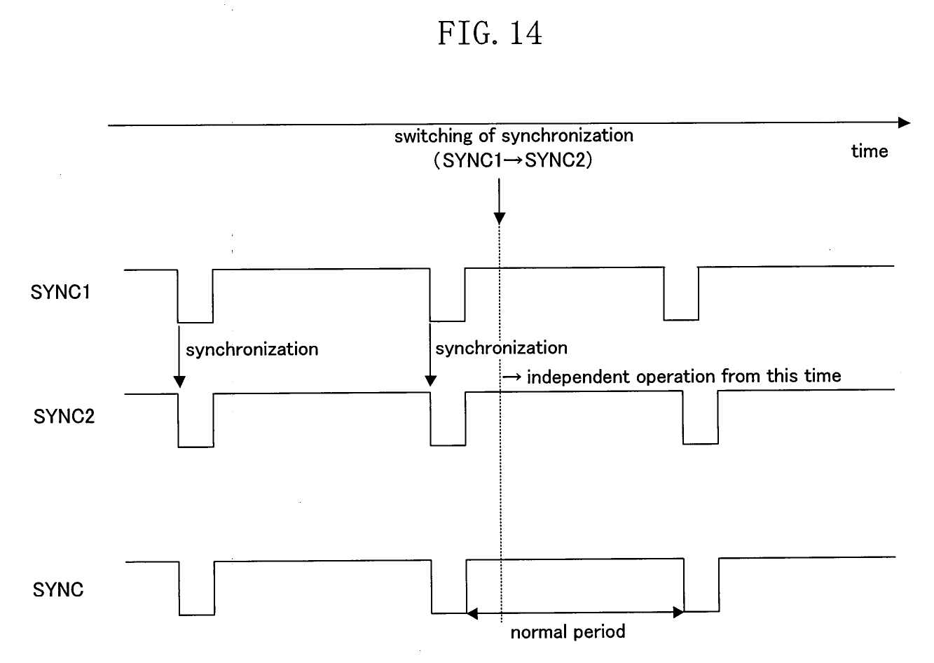

FIG. 15 is a timing chart illustrating conventional switching of synchronization signals.

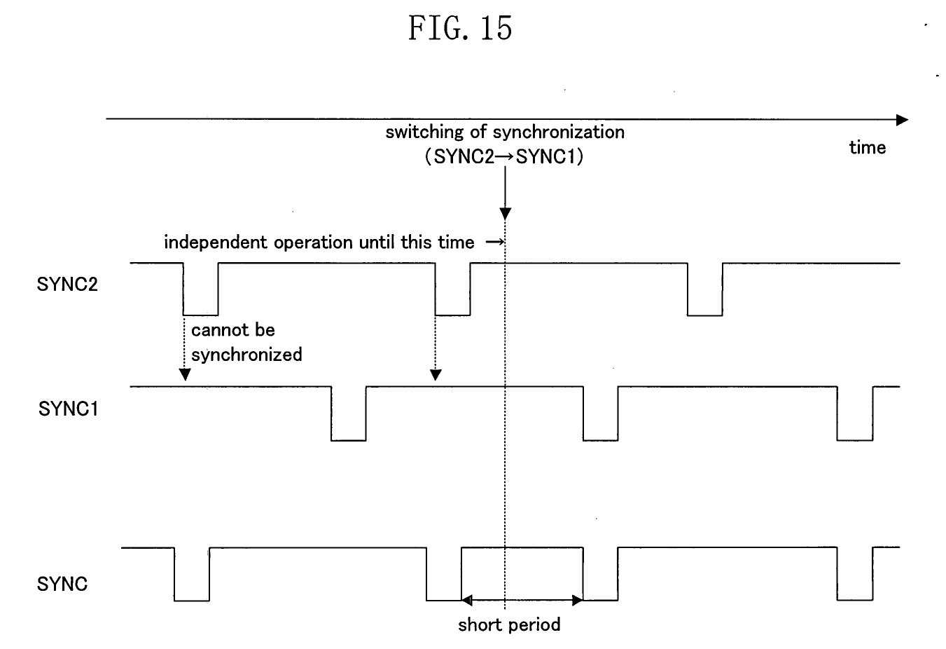

### DESCRIPTION OF THE PREFERRED EMBODIMENTS

Hereinafter, preferred embodiments of the present invention will be described with reference to the accompanying drawings.

### First Embodiment

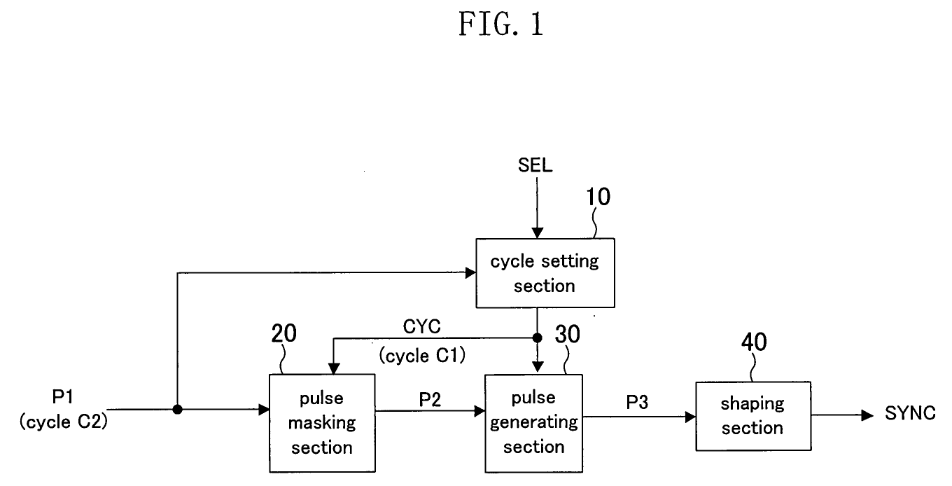

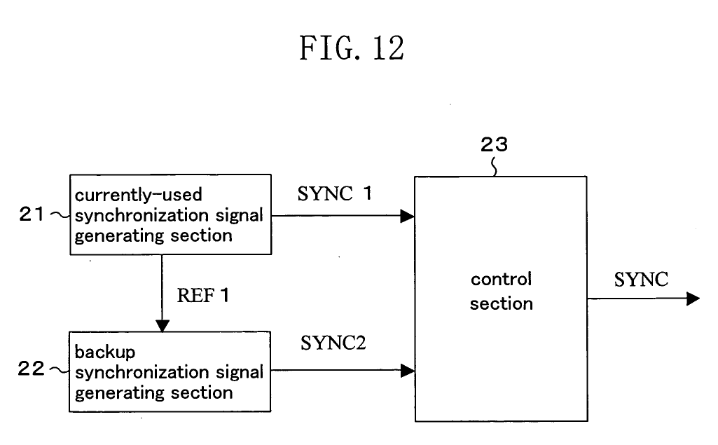

FIG. 1 illustrates a structure of a synchronization signal generating apparatus according to a first embodiment. The synchronization signal generating apparatus of this embodiment comprises a cycle setting section 10, a pulse masking section 20, a pulse generating section 30, and a shaping section 40. The cycle setting section 10 outputs cycle information CYC indicating a cycle C1. The pulse masking section 20 outputs a pulse train P2 based on both a pulse train P1 and the cycle information CYC. The pulse train P1 corresponds to the synchronization signal SYNC1 in the conventional synchronization signal generating apparatus of FIG. 12. Specifically, the pulse masking section 20 outputs the pulse train P1 as the pulse train P2 when C1>C2 where C2 denotes the cycle of a pulse of the pulse train P1, and outputs a signal obtained by masking pulse(s) in the pulse train P1 as the pulse train P2 when C1≦C2. The pulse generating section 30 outputs a pulse train P3 based on both the pulse train P2 and the cycle information CYC. Specifically, when receiving a pulse from the pulse masking section 20 within the cycle C1 after outputting one pulse, the pulse generating section 30 outputs the next pulse. On the other hand, when a pulse is not input from the pulse masking section 20, the pulse generating section 30 outputs the next pulse after the cycle C1 has elapsed. The shaping section 40 shapes the pulse train P3 to output a synchronization signal SYNC.

The cycle setting section 10 switches the cycle information CYC based on both the pulse train P1 and a cycle selection signal SEL. Specifically, when the cycle selection signal SEL indicates selection of a decrease in the cycle C1, the cycle setting section 10 switches the cycle information CYC to information indicating the cycle C1 selected using the cycle selection signal SEL upon receiving a pulse of the pulse train P1 for the first time since the cycle selection signal SEL was changed. On the other hand, when the cycle selection signal SEL indicates selection of an increase in the cycle C1, the cycle setting section 10 switches the cycle information CYC to information indicating the cycle C1 selected using the cycle selection signal SEL after receiving a pulse of the pulse train P1 since the cycle selection signal SEL was changed.

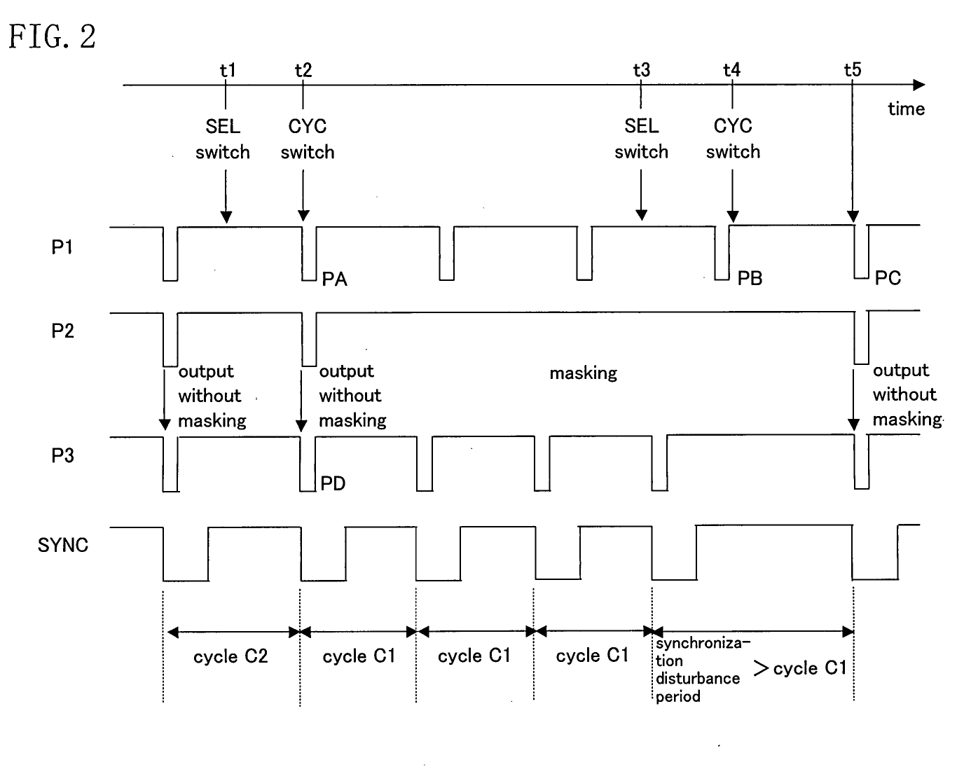

Hereinafter, an operation of the synchronization signal generating apparatus of this embodiment will be described with reference to a timing chart illustrated in FIG. 2.

Until time t1, the cycle C1 indicated by the cycle information CYC is larger than the cycle C2 of the pulse train P1, i.e., C1>C2. Therefore, the synchronization signal SYNC is in synchronization with the pulse train P1.

Because the pulse train P1 becomes unstable, the synchronization signal SYNC needs to be switched, so that the cycle selection signal SEL is changed at time t1. In this case, the cycle selection signal SEL indicates selection of a decrease in the cycle C1 so that the cycle C1 is caused to be smaller than the cycle C2. However, the cycle information CYC is not immediately switched, and is switched at time t2 when a pulse PA of the pulse train P1 is output. Also, pulses of the pulse trains P2 and P3 are output, corresponding to the output of the pulse PA of the pulse train P1 at time t2. Therefore, the synchronization signal SYNC is in synchronization with the pulse train P1 having the cycle C2 until time t2.

After time t2, because C1≦C2 until the cycle information CYC is switched, the pulse masking section 20 masks pulse(s) of the pulse train P1, so that a pulse is not output from the pulse masking section 20. Therefore, the pulse generating section 30 outputs the pulse train P3 having the cycle C1. In other words, at time t2, the synchronization signal SYNC is switched to an independent synchronization signal having the cycle C1.

Thereafter, the pulse train P1 becomes stable, and at time t3, the cycle selection signal SEL is changed so that the synchronization signal SYNC is synchronized again with the pulse train P1. In this case, the cycle selection signal SEL is used to select an increase in the cycle C1 so that the cycle C1 is caused to be larger than the cycle C2. However, the cycle information CYC is not immediately switched, and is switched at time t4 after a pulse PB of the pulse train P1 is output. Therefore, at the time when the pulse PB is output, the cycle information CYC has not yet been switched, and the pulse PB of the pulse train P2 is masked. Therefore, even when the pulse PB is output, the pulse generating section 30 does not output a pulse.

Thereafter, at time t5, when a pulse PC of the pulse train P1 is output, the pulse masking section 20 outputs the pulse PC without masking. The pulse generating section 30 outputs the next pulse when receiving the pulse from the pulse masking section 20. As a result, a pulse which is in synchronization with the pulse train P1 appears in the synchronization signal SYNC. After time t5, the synchronization signal SYNC is again in synchronization with the pulse train P1. Here, a synchronization disturbance occurs in the synchronization signal SYNC after time t3, and the synchronization disturbance has a cycle longer than the cycle C1.

As described above, according to this embodiment, when the synchronization signal SYNC is returned from the independent state to the state of being in synchronization with the pulse train P1, the occurrence of the problematic synchronization signal having a short synchronization period is avoided.

Note that, when the cycle selection signal SEL indicates selection of a decrease in the cycle C1, the cycle setting section 10 may switch the cycle information CYC to information indicating the cycle C1 selected using the cycle selection signal SEL upon receiving a pulse of the pulse train P3 for the first time since the cycle selection signal SEL was changed. Specifically, in FIG. 2, when a pulse PD of the pulse train P3 is output at time t2, the cycle information CYC may be switched.

### Second Embodiment

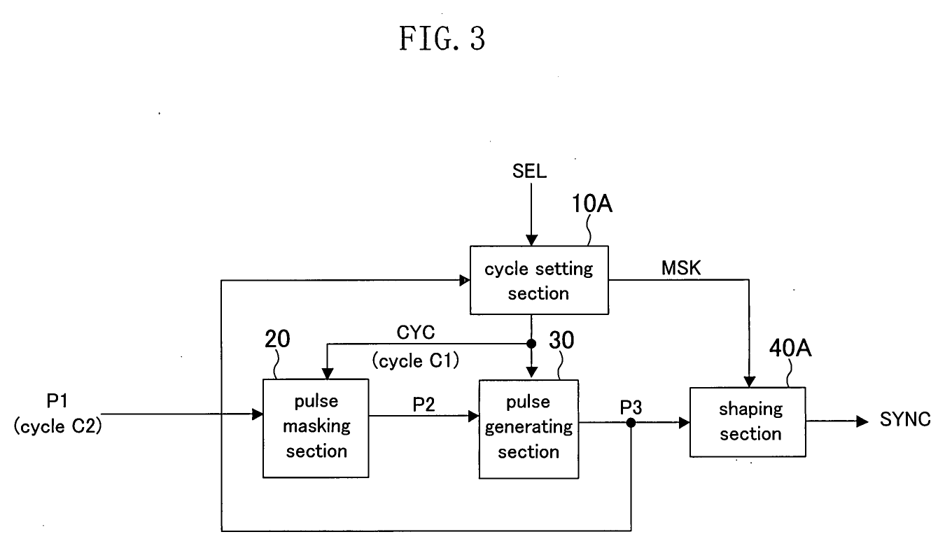

FIG. 3 illustrates a structure of a synchronization signal generating apparatus according to a second embodiment. The synchronization signal generating apparatus of this embodiment comprises a cycle setting section 10A, a pulse masking section 20, a pulse generating section 30, and a shaping section 40A. The pulse masking section 20 and the pulse generating section 30 are similar to those of the first embodiment and will not be described. Hereinafter, the cycle setting section 10A and the shaping section 40A will be particularly described.

The cycle setting section 10A switches cycle information CYC based on both a pulse train P3 and a cycle selection signal SEL. Specifically, when the cycle selection signal SEL indicates selection of a decrease in the cycle C1, the cycle setting section 10A switches the cycle information CYC to information indicating the cycle C1 selected using the cycle selection signal SEL upon receiving a pulse of the pulse train P3 for the first time since the cycle selection signal SEL was changed. On the other hand, when the cycle selection signal SEL indicates selection of an increase in the cycle C1, the cycle setting section 10A switches the cycle information CYC to information indicating the cycle C1 selected using the cycle selection signal SEL after receiving a pulse of the pulse train P3 since the cycle selection signal SEL was changed. Particularly, when the cycle selection signal SEL indicates selection of an increase in the cycle C1, the cycle setting section 10A outputs a mask signal MSK during a time from when the cycle selection signal SEL is changed until the cycle information CYC is switched.

The shaping section 40A subjects pulse(s) of the pulse train P3 to a mask process and outputs the synchronization signal SYNC during a time when the mask signal MSK is being output from the cycle setting section 10A. In other words, the shaping section 40A also functions as a pulse masking section which masks pulse(s) of the pulse train P3.

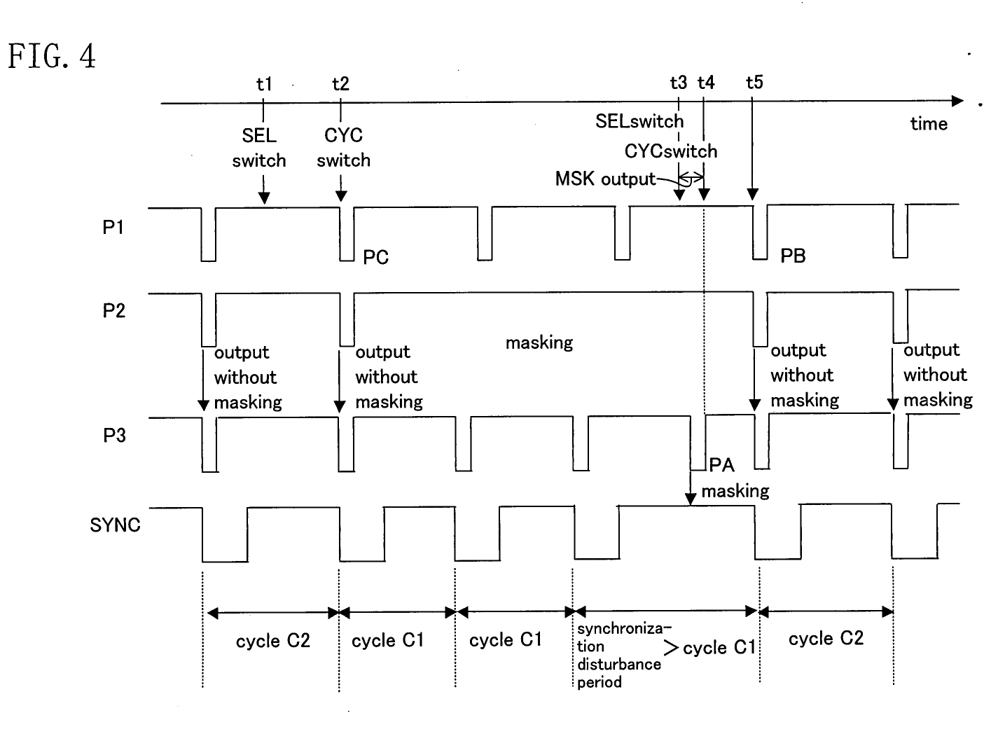

Hereinafter, an operation of the synchronization signal generating apparatus of this embodiment will be described with reference to a timing chart illustrated in FIG. 4. Note that the process until time t3 is similar to that illustrated in the timing chart of FIG. 2 and will not be described.

At time t3, the pulse train P1 becomes stable, and the cycle selection signal SEL is changed so that the synchronization signal SYNC is returned from the independent state to the state of being in synchronization with the pulse train P1. In this case, the cycle selection signal SEL is used to select an increase in the cycle C1 so that the cycle C1 is caused to be larger than the cycle C2. However, the cycle information CYC is not immediately switched, and is switched at time t4 after a pulse PA of the pulse train P3 is output.

The mask signal MSK is output during a time from when the cycle selection signal SEL is changed at time t3 as described above until the cycle information CYC is switched at time t4. Because pulse(s) of the pulse train P3 are masked by the shaping section 40A during a time when the mask signal MSK is being output, a pulse corresponding to the pulse PA does not appear in the synchronization signal SYNC.

After time t4, at time t5 when a pulse PB of the pulse train P1 is output, the cycle information CYC has already been switched, so that C1>C2. Therefore, the pulse PB of the pulse train P1 is not masked by the pulse masking section 20, and pulses of the pulse trains P2 and P3 are output, corresponding to the output of the pulse PB. As a result, after time t5, the synchronization signal SYNC is again in synchronization with the pulse train P1.

At time t5, the mask signal MSK is not output, and therefore, pulses of the pulse train P3 are not masked by the shaping section 40A. Therefore, after the cycle selection signal SEL is changed at time t3, a pulse first appears in the synchronization signal SYNC at time t5. Here, although a synchronization disturbance occurs in the synchronization signal SYNC due to the change in the cycle selection signal SEL at time t3, this synchronization disturbance has a cycle longer than the cycle C1.

As described above, according to this embodiment, when the synchronization signal SYNC is returned from the independent state to the state of being in synchronization with the pulse train P1, the occurrence of the problematic synchronization signal having a short synchronization period is avoided.

Note that, when the cycle selection signal SEL indicates selection of a decrease in the cycle C1, the cycle setting section 10A may switch the cycle information CYC to information indicating the cycle C1 selected using the cycle selection signal SEL upon receiving a pulse of the pulse train P3 for the first time since the cycle selection signal SEL was changed. Specifically, in FIG. 4, when a pulse PC of the pulse train P1 is output at time t2, the cycle information CYC may be switched.

### Third Embodiment

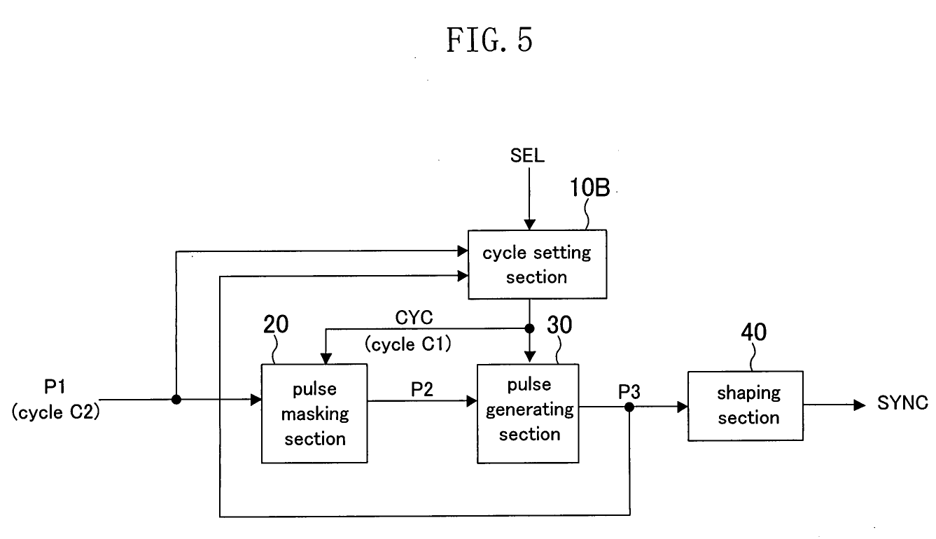

FIG. 5 illustrates a structure of a synchronization signal generating apparatus according to a third embodiment. The synchronization signal generating apparatus of this embodiment comprises a cycle setting section 10B, a pulse masking section 20, a pulse generating section 30, and a shaping section 40. The pulse masking section 20, the pulse generating section 30, and the shaping section 40 are similar to those of the first embodiment and will not be described. Hereinafter, the cycle setting section 10B will be particularly described.

The cycle setting section 10B switches cycle information CYC based on all of pulse trains P1 and P3 and a cycle selection signal SEL. Specifically, when the cycle selection signal SEL indicates an decrease in the cycle C1, the cycle setting section 10B switches the cycle information CYC to information indicating the cycle C1 selected using the cycle selection signal SEL upon receiving a pulse in any one of the pulse trains P1 and P3 for the first time since the cycle selection signal SEL was changed. On the other hand, when the cycle selection signal SEL indicates an increase in the cycle C1, the cycle setting section 10B switches the cycle information CYC to information indicating the cycle C1 selected using the cycle selection signal SEL after a difference in phase between the pulse train P1 and the pulse train P3 becomes a predetermined value or less (or less than the predetermined value).

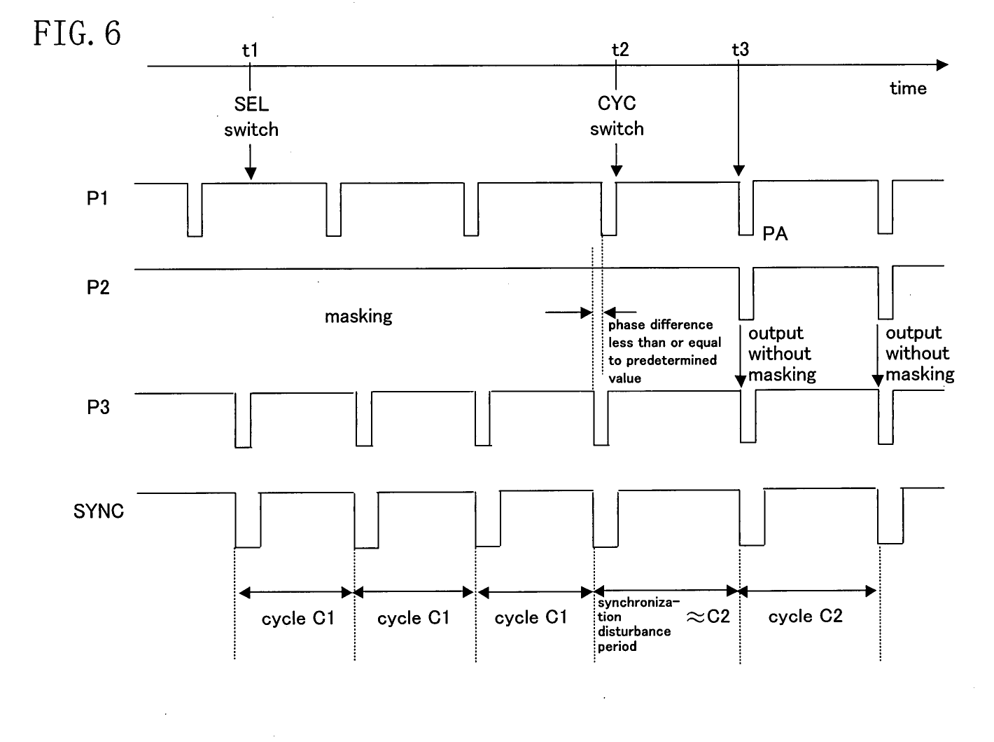

Hereinafter, an operation of the synchronization signal generating apparatus of this embodiment, particularly an operation thereof when the synchronization signal SYNC is returned from the independent state to the state of being in synchronization with the pulse train P1, will be described with reference to a timing chart illustrated in FIG. 6.

At time t1, the cycle selection signal SEL is changed so that the synchronization signal SYNC is returned from the independent state to the state of being in synchronization with the pulse train P1. In this case, the cycle selection signal SEL is used to select an increase in the cycle C1 so that the cycle C1 is caused to be larger than the cycle C2. However, the cycle information CYC is not immediately switched, and is switched at time t2 after the phase difference between the pulse train P1 and the pulse train P3 becomes the predetermined value or less (or less than the predetermined value). Therefore, until time t2, the synchronization signal SYNC continues to have the cycle C1 in the independent state.

After time t2, at time t3 when a pulse PA of the pulse train P1 is output, the cycle information CYC has already been switched, so that C1>C2. Therefore, the pulse PA of the pulse train P1 is not masked by the pulse masking section 20, and pulses of the pulse trains P2 and P3 are output, corresponding to the output of the pulse PA. After time t3, the synchronization signal SYNC is again in synchronization with the pulse train P1. Here, a synchronization disturbance occurs in the synchronization signal SYNC due to switching of the cycle information CYC at time t2. This synchronization disturbance has substantially the same cycle as the cycle C2, and more correctly, a cycle longer by the phase difference between the pulse train P1 and the pulse train P3 than the cycle C2.

As described above, according to this embodiment, when the synchronization signal SYNC is returned from the independent state to the state of being in synchronization with the pulse train P1, the synchronization disturbance is suppressed according to the first and second embodiments.

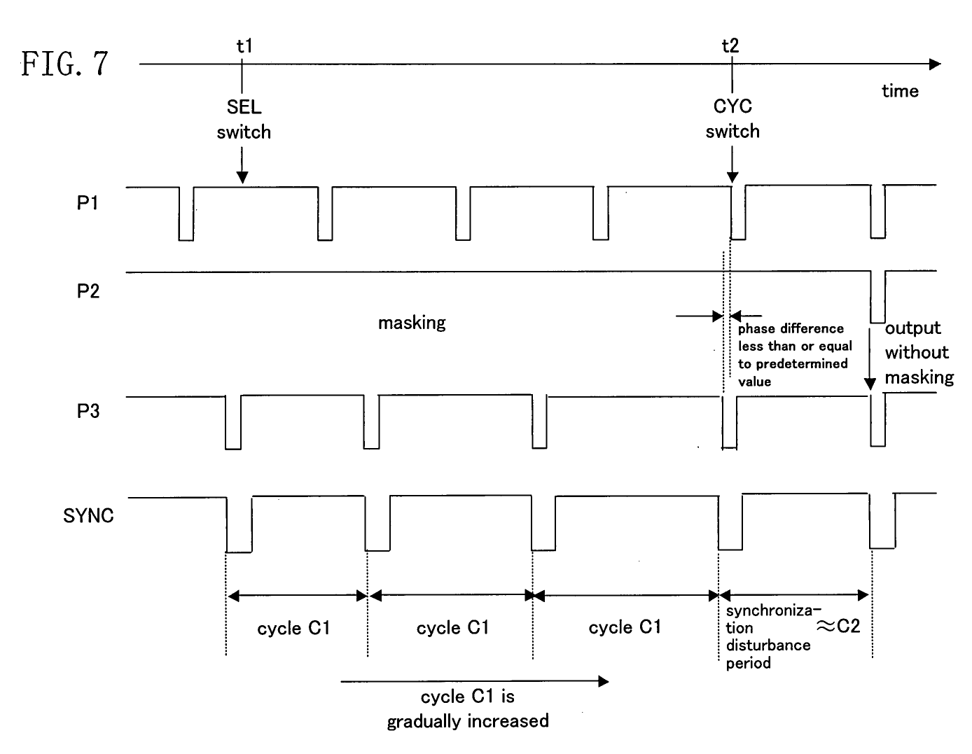

Note that, even in the case where the cycle selection signal SEL is changed at time t1 to indicate switching of the cycle information CYC, if C1=C2, the phase difference between the pulse train P1 and the pulse train P3 is kept constant and is not changed, so that the cycle information CYC cannot be switched. Therefore, in this case, the cycle C1 is gradually increased. FIG. 7 is a timing chart when the cycle C1 is gradually increased. After time t1, the cycle C1 is gradually increased, so that the phase difference between the pulse train P1 and the pulse train P3 becomes the predetermined value or less (or less than the predetermined value) at time t2. Thereby, the cycle information CYC is switched, so that the synchronization signal SYNC is synchronized with the pulse train P1.

### Fourth Embodiment

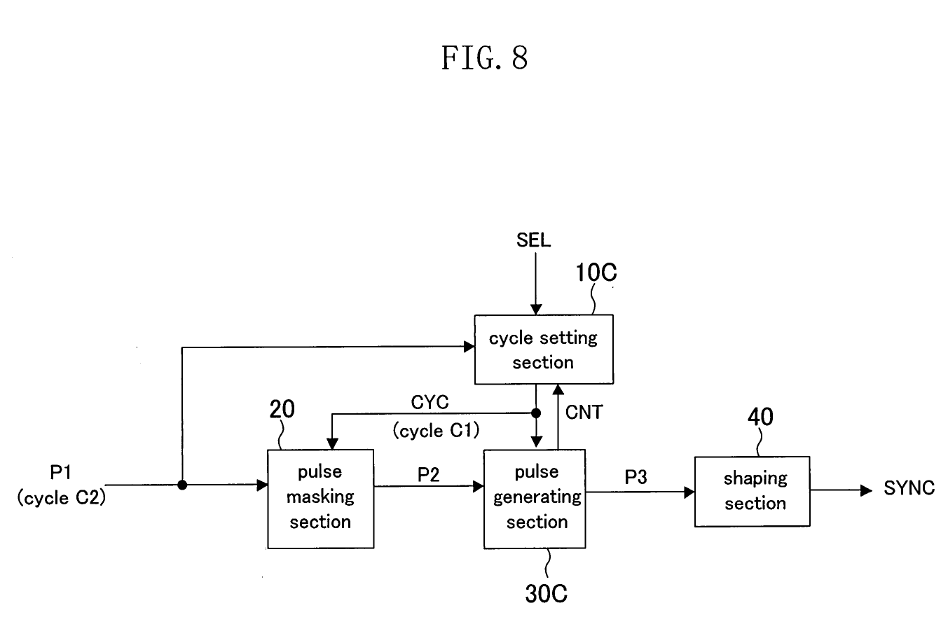

FIG. 8 illustrates a structure of a synchronization signal generating apparatus according to a fourth embodiment. The synchronization signal generating apparatus of this embodiment comprises a cycle setting section 10C, a pulse masking section 20, a pulse generating section 30C, and a shaping section 40. The pulse masking section 20 and the shaping section 40 are similar to those of the first embodiment and will not be described. Hereinafter, particularly, the cycle setting section 10C and the pulse generating section 30C will be described.

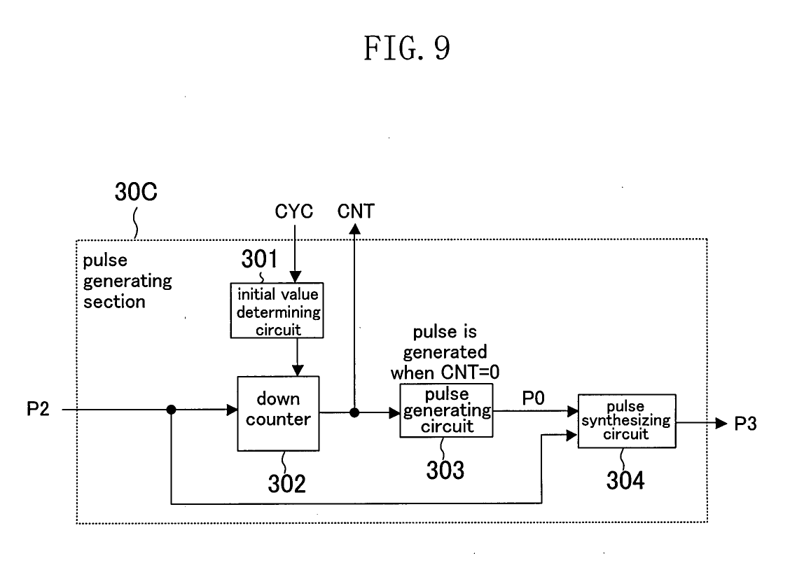

FIG. 9 illustrates an internal structure of the pulse generating section 30C. The pulse generating section 30C comprises an initial value determining circuit 301, a down counter 302, a pulse generating circuit 303, and a pulse synthesizing circuit 304. The initial value determining circuit 301 determines a counter initial value from the cycle information CYC. The down counter 302 reads the counter initial value from the initial value determining circuit 301 every time it receives a pulse of a pulse train P2, and decrements the value at predetermined intervals to output a counter value CNT. When a pulse of the pulse train P2 is not input, the down counter 302 reads the counter initial value from the initial value determining circuit 301 every time the counter value CNT becomes a predetermined value (e.g., “0”), and decrements the value at predetermined intervals to output the counter value CNT. The pulse generating circuit 303 outputs a pulse as a pulse train P0 every time the counter value CNT becomes a predetermined value (e.g., “0”). When receiving a pulse of any one of the pulse trains P2 and P0, the pulse synthesizing circuit 304 outputs a pulse as a pulse train P3. Therefore, when the input pulse of the pulse train P2 has a cycle shorter than the cycle C1, the pulse generating section 30C outputs a pulse, corresponding to the pulse input, and when a pulse of the pulse train P2 is not input within the cycle C1 after outputting a pulse, outputs the next pulse.

The cycle setting section 10C switches cycle information CYC based on a pulse train P1, a cycle selection signal SEL, and the counter value CNT. Specifically, when the cycle selection signal SEL indicates a decrease in the cycle C1, the cycle setting section 10C switches the cycle information CYC to information indicating the cycle C1 selected using the cycle selection signal SEL upon receiving a pulse of the pulse train P1 for the first time since the cycle selection signal SEL was changed. On the other hand, when the cycle selection signal SEL indicates an increase in the cycle C1, the cycle setting section 10C switches the cycle information CYC to information indicating the cycle C1 selected using the cycle selection signal SEL if the counter value CNT when a pulse of the pulse train P1 is received for the first time since the cycle selection signal SEL was changed is less than a predetermined value (or the predetermined value or less).

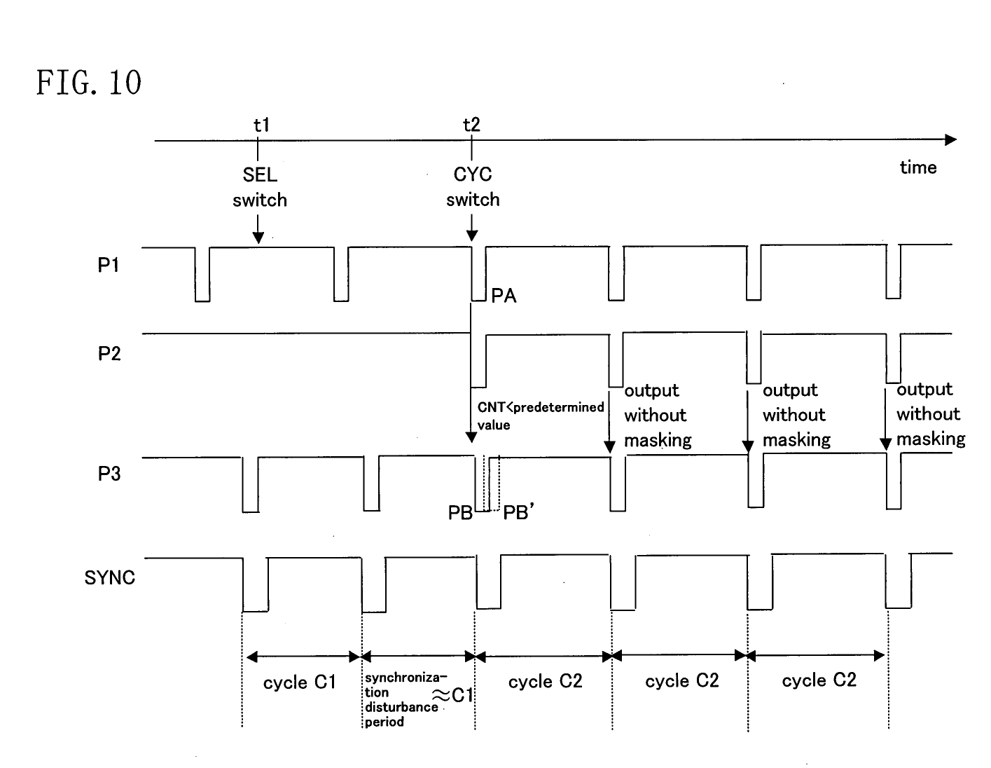

Hereinafter, an operation of the synchronization signal generating apparatus of this embodiment, particularly an operation thereof when the synchronization signal SYNC is returned from the independent state to the state of being in synchronization with the pulse train P1, will be described with reference to a timing chart illustrated in FIG. 10.

At time t1, the cycle selection signal SEL is changed so that the synchronization signal SYNC is returned from the independent state to the state of being in synchronization with the pulse train P1. In this case, the cycle selection signal SEL is used to select an increase in the cycle C1 so that the cycle C1 is caused to be larger than the cycle C2. However, the cycle information CYC is not immediately switched, and is switched if the counter value CNT when a pulse of the pulse train P1 is received after time t1 becomes less than the predetermined value (or the predetermined value or less).

In the timing chart of FIG. 10, when a pulse PA of the pulse train P1 is output at time t2, the counter value CNT is less than the predetermined value (or the predetermined value or less). Therefore, the cycle information CYC is switched, so that C1>C2. Thereby, the pulse PA is not masked by the pulse masking section 20, and a pulse of the pulse train P2 and a pulse PB of the pulse train P3 are output, corresponding to the pulse PA. The pulse PB is output slightly earlier than a pulse (pulse PB′ indicated with a dashed line in FIG. 10) which would be output if the cycle information CYC was not switched at time t2. In this case, a synchronization disturbance occurs, but the disturbance is slightly shorter than the cycle C1. The disturbance also has, at the maximum, a period of time corresponding to the predetermined value which is compared with the counter value CNT. Therefore, by setting the predetermined value as appropriate, a short pulse is permitted within a range which does not have an influence on an operation of the apparatus when the synchronization signals are switched, thereby suppressing the synchronization disturbance.

After time t2, because C1>C2, the pulse train P1 is output as the pulse train P2. As a result, the pulse train P3 is synchronized with the pulse train P1, so that the synchronization signal SYNC has a cycle of C2. In other words, the synchronization signal SYNC is synchronized with the pulse train P1.

As described above, according to this embodiment, when the synchronization signal SYNC is returned from the independent state to the state of being in synchronization with the pulse train P1, a pulse having a short period of time is output, but the synchronization disturbance is suppressed to such an extent that an operation of the apparatus is not influenced.

Note that the above-described embodiments may be combined as appropriate to construct a synchronization signal generating apparatus. In the foregoing description, the single pulse train P1 is used as an input. Alternatively, two or more pulse trains may be used as inputs, and in this case, a synchronization signal generating apparatus can be constructed in a manner similar to that of the above-described embodiments.

In each of the above-described embodiments, the pulse masking section 20 may mask pulse(s) of the pulse train P1 when the cycle C1 is larger than or equal to the cycle C2 (C1≧C2) or when the cycle C1 is smaller than the cycle C2 (C1<C2). In other words, it may be determined whether or not the masking process is performed, depending on a relationship in size between the cycle C1 and the cycle C2.

In the foregoing description, all pulses illustrated in the drawings referenced above have a negative polarity, but may have a positive polarity without impairing the effects of the present invention.

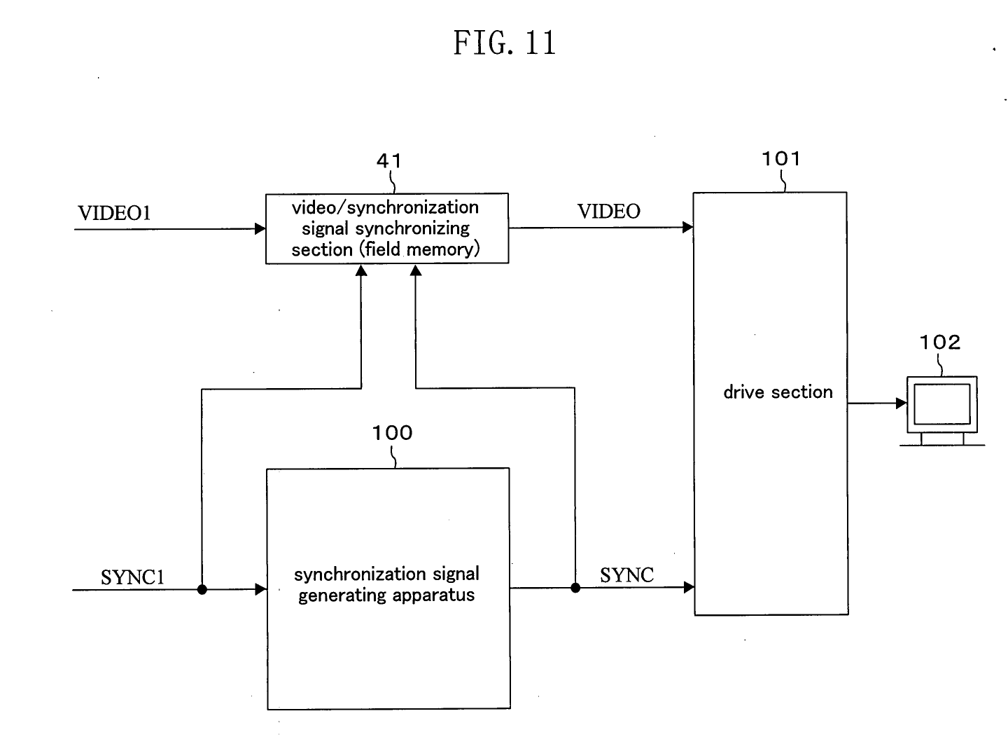

FIG. 11 illustrates a structure of a video signal processing apparatus according to the present invention. The video signal processing apparatus comprises a video/synchronization signal synchronizing section (field memory) 41, a synchronization signal generating apparatus 100 according to the present invention, a drive section 101, and a display section 102. As described above, the synchronization signal generating apparatus 100 outputs a stable synchronization signal SYNC. The drive section 101 receives a video signal VIDEO and the synchronization signal SYNC from the video/synchronization signal synchronizing section 41 and the synchronization signal generating apparatus 100, respectively, and based on these signals, drives the display section 102. Thus, by incorporating the synchronization signal generating apparatus according to the present invention, a video signal processing apparatus in which a synchronization disturbance is suppressed can be achieved.

What is claimed is:

1. A synchronization signal generating apparatus comprising:
a cycle setting section of switching and outputting cycle information indicating a first cycle, corresponding to a given cycle selection signal;
a pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state; and
a pulse generating section of outputting a second pulse train, wherein when a pulse is input from the pulse masking section within the first cycle indicated by the cycle information after outputting a pulse, the pulse generating section outputs a next pulse, corresponding to the pulse input, and when the input is not present, the pulse generating section outputs a next pulse after the first cycle has elapsed,
wherein, when the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information after receiving a pulse of the first pulse train for the first time since the cycle selection signal was changed.

2. A synchronization signal generating apparatus comprising:
a cycle setting section of switching and outputting cycle information indicating a first cycle, corresponding to a given cycle selection signal, and outputting a mask signal;
a first pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state;
a pulse generating section of outputting a second pulse train, wherein when a pulse is input from the pulse masking section within the first cycle indicated by the cycle information after outputting a pulse, the pulse generating section outputs a next pulse, corresponding to the pulse input, and when the input is not present, the pulse generating section outputs a next pulse after the first cycle has elapsed; and
a second pulse masking section of masking pulses of the second pulse train during a time when the mask signal is being output from the cycle setting section,
wherein, when the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information after receiving a pulse of the second pulse train for the first time since the cycle selection signal was changed, and outputs the mask signal during a time from when the cycle selection signal was changed until when the cycle information is switched.

3. A synchronization signal generating apparatus comprising:
a cycle setting section of switching and outputting cycle information indicating a first cycle, corresponding to a given cycle selection signal;
a pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state; and
a pulse generating section of outputting a second pulse train, wherein when a pulse is input from the pulse masking section within the first cycle indicated by the cycle information after outputting a pulse, the pulse generating section outputs a next pulse, corresponding to the pulse input, and when the input is not present, the pulse generating section outputs a next pulse after the first cycle has elapsed,
wherein, when the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information after a phase difference between the first pulse train and the second pulse train becomes a predetermined value or less.

4. The synchronization signal generating apparatus of claim 3, wherein, when the cycle selection signal indicates selection of a change in the first cycle so that the size relationship is put into the first state, the cycle setting section gradually increases the first cycle.

5. A synchronization signal generating apparatus comprising:
a cycle setting section of switching and outputting cycle information indicating a first cycle, corresponding to a given cycle selection signal;
a pulse masking section of receiving a first pulse train, and outputting the first pulse train when a relationship in size between the first cycle and a second cycle of the first pulse train is in a first state, and a signal obtained by masking pulses of the first pulse train when the size relationship is in a second state; and
a pulse generating section of outputting a second pulse train, wherein, when receiving a pulse from the pulse masking section, the pulse generating section sets a counter value to be an initial value corresponding to the first cycle indicated by the cycle information and starts to count down the counter value, and when receiving a next pulse from the pulse masking section or when the counter value becomes a first predetermined value, whichever comes first, the pulse generating section outputs a pulse,
wherein the counter value is reset to be the initial value after the counter value becomes the first predetermined value by counting down, and
when the cycle selection signal indicates selection of a change in the first cycle so that the size relationship is put into the first state, the cycle setting section switches the cycle information upon receiving a pulse of any one of the first and second pulse trains for the first time since the cycle selection signal was changed, and when the cycle selection signal indicates selection of a change in the first cycle so that the size relationship is put into the second state, the cycle setting section switches the cycle information if the counter value is less than a second predetermined value upon receiving a pulse of the first pulse train for the first time since the cycle selection signal was changed.

6. The synchronization signal generating apparatus of claim 5, wherein the pulse generating section comprises:
an initial value determining circuit of determining the initial value from the cycle information;
a down counter of reading the initial value from the initial value determining circuit and starting to count down the counter value either when receiving a pulse from the pulse masking section or when the counter value reaches the first predetermined value;
a pulse generating circuit of outputting a pulse when the counter value reaches the first predetermined value; and
a pulse synthesizing circuit of outputting a pulse received from any of the pulse masking section and the pulse generating circuit.

7. The synchronization signal generating apparatus of claim 1, wherein the first state is such that the first cycle is larger than the second cycle.

8. The synchronization signal generating apparatus of claim 2, wherein the first state is such that the first cycle is larger than the second cycle.

9. The synchronization signal generating apparatus of claim 3, wherein the first state is such that the first cycle is larger than the second cycle.

10. The synchronization signal generating apparatus of claim 5, wherein the first state is such that the first cycle is larger than the second cycle.

11. A video signal processing apparatus comprising the synchronization signal generating apparatus of claim 1, wherein
a video signal is processed in synchronization with the second pulse train output from the synchronization signal generating apparatus.

12. A video signal processing apparatus comprising the synchronization signal generating apparatus of claim 2, wherein
a video signal is processed in synchronization with the second pulse train output from the synchronization signal generating apparatus.

13. A video signal processing apparatus comprising the synchronization signal generating apparatus of claim 3, wherein
a video signal is processed in synchronization with the second pulse train output from the synchronization signal generating apparatus.

14. A video signal processing apparatus comprising the synchronization signal generating apparatus of claim 5, wherein
a video signal is processed in synchronization with the second pulse train output from the synchronization signal generating apparatus.
